(19) United States
(12) Patent Application Publication
(10) Pub. No.: US 2006/0010290 A1
(43) Pub. Date: Jan. 12, 2006

(54) Logical disk management method and apparatus

(76) Inventor: Kyoichi Sasamoto, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/175,319

(22) Filed: Jul. 7, 2005

(30) Foreign Application Priority Data
Jul. 8, 2004 (JP) 2004-202118

(51) Int. Cl. G06F 12/00

(52) U.S. Cl. 711/114; 711/170; 711/202

(57) ABSTRACT

An array/slice definition unit constitutes an array composed of a group of slices. The array is constituted by defining a storage area in a disk drive as a single physical array area of the array. The physical array area is divided to a plurality of areas under a certain capacity, and the divided areas are defined as the slices. A logical disk definition unit constitutes a logical disk by combining arbitrary plural slices of the slices contained in the array. A slice moving unit exchanges an arbitrary first slice entered into the logical disk and a second slice not entered into any logical disk including the logical disk.

### CROSS-REFERENCE TO RELATED APPLICATIONS

This application is based upon and claims the benefit of priority from prior Japanese Patent Application No. 2004-202118, filed Jul. 8, 2004, the entire contents of which are incorporated herein by reference.

### BACKGROUND OF THE INVENTION

1. Field of the Invention

The present invention relates to a logical disk management method and apparatus for managing a logical disk which utilizes a storage area of a disk drive and which is recognized as a single disk area (a disk volume) by a host computer (a host).

2. Description of the Related Art

In general, a disk array apparatus comprises a plurality of disk drives such as hard disk drives (HDDs), and an array controller connected to the HDDs. The array controller manages the HDDs by use of the generally-known RAID (Redundant Arrays of Independent Disks; or Redundant Arrays of Inexpensive Disks) technology. In response to a data read/write request made by the host (host computer), the array controller controls the HDDs in parallel in such a manner as to comply with the data read/write request in a distributed fashion. This enables the disk array apparatus to execute high-speed the data access requested by the host. The disk array apparatus also enhances reliability with its redundant disk configuration.

In the conventional disk array apparatus, the physical arrangement of the logical disk recognized by the host is static. For this reason, the conventional disk array apparatus is disadvantageous in that the relationships between the block addresses of the logical disk and the corresponding array configurations do not vary in principle. Likewise, the relationships between the block addresses of the logical disk and the corresponding block addresses of the HDDs do not vary in principle.

After the disk array apparatus is operated, it sometimes happens that the access load amount exerted on the logical disk differs from the initially estimated value. Also it sometimes happens that the access load varies with time. In such cases, the conventional disk array apparatus cannot easily eliminate a bottle neck or a hot spot which may occur in the array of the logical disk or in the HDDs. This is because the correspondence between the logical disk and the array and that between the logical disk and the HDDs are static. To solve the problems of the bottle neck and hot spot, the data stored in the logical disk has to be backed up on a tape, for example, and a new logical disk has to be reconstructed from the beginning. In addition, the backup data has to be restored from the tape to the reconstructed logical disk. It should be noted that the “hot spot” used herein refers to the state where an access load is concentratedy exerted on a particular area of the HDDs.

In recent years, there are many cases where a plurality of hosts share the same disk array apparatus. In such cases, an increase in the number of hosts connected to one disk array apparatus may change the access load, resulting in a bottle neck or a hot spot. However, the physical arrangement of the logical disk are static in the conventional disk array apparatus. Once the conventional disk array apparatus is put to use, it is not easy to cope with changes in the access load.

In an effort to solve the problems described above, Jpn. Pat. Appln. KOKAI Publication No. 2003-5920 proposes the art for rearranging logical disks in such an optimal manner as to conform to the I/O characteristics of physical disks by using values representing the performance of input/output processing (I/O performance) of the HDDs (physical disks). The art proposed in KOKAI Publication 2003-5920 will be hereinafter referred to as the prior art. In the prior art, the busy rate of each HDD is controlled to be an optimal busy rate.

The rearrangement of logical disks the prior art proposes may reduce the access load, if viewed in the entire logical disks. However, the prior art rearranges the logical disks in units of one logical disk. If a bottle neck or a hot spot occurs in the array or HDDs constituting one logical disk, the prior art cannot eliminate such a bottle neck or hot spot.

### BRIEF SUMMARY OF THE INVENTION

According to one embodiment of the present invention, there is provided a method for managing a logical disk. The logical disk is constituted by using a storage area of a disk drive and recognized as a single disk volume by a host. The method comprises: constituting an array, the array being constituted by defining the storage area of the disk drive as a physical array area of the array, the array being constituted of a group of slices, the physical array area being divided to a plurality of areas having a certain capacity, the divided areas being defined as the slices; constituting a logical disk by combining arbitrary plural slices of the slices contained in the array; and exchanging an arbitrary first slice entered into the logical disk with a second slice not entered into any logical disk including the logical disk.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a computer system provided with a disk array apparatus according to one embodiment of the present invention.

FIGS. 2A and 2B illustrate the definitions of an array and a slice which are applied to the embodiment.

FIG. 3 illustrates the definition of a logical disk applied to the embodiment.

FIG. 4 illustrates an example of a data structure of the map table 122 shown in FIG. 1.

FIG. 5A is a flowchart illustrating how slice movement is started in the embodiment.

FIG. 5B is a flowchart illustrating how slice movement is ended in the embodiment.

FIG. 6 is a flowchart illustrating how data write processing is executed in the embodiment.

FIG. 7 illustrates how to store the map table 122 in the embodiment.

FIG. 8 illustrates a method which the embodiment uses for reducing the HDD seek operation.

FIG. 9 illustrates a method which the embodiment uses for eliminating a hot spot in the array.

FIG. 10 illustrates a method which the embodiment uses for optimizing the RAID level.

FIG. 11 illustrates a method which the embodiment uses for expanding the storage capacity of a logical disk.

FIG. 12 is a block diagram illustrating a computer system according to a first modification of the embodiment.

FIG. 13 is a block diagram illustrating a computer system provided with a disk array apparatus according to a second modification of the embodiment.

FIG. 14 illustrates a method which the second modification uses for eliminating drop in read performance of a logical disk.

FIG. 15 illustrates a method which the second modification uses for eliminating drop in write performance of the logical disk.

FIG. 16 illustrates a method which the second modification uses for improving cost performance of the disk array apparatus.

FIG. 17 illustrates a method which a third modification of the embodiment uses for constructing an array.

### DETAILED DESCRIPTION OF THE INVENTION

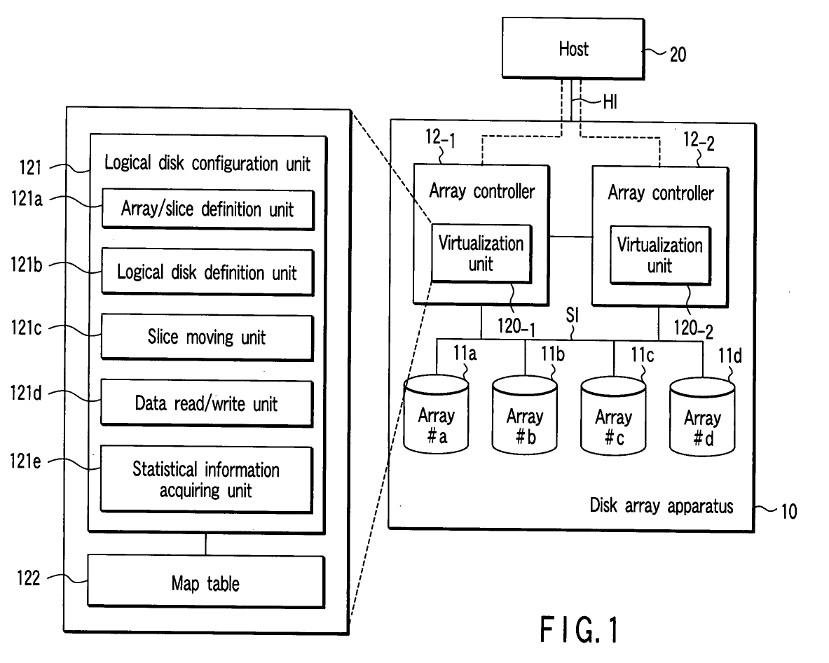

An embodiment of the present invention will now be described with reference to the accompanying drawings. FIG. 1 is a block diagram illustrating a computer system provided with a disk array apparatus according to one embodiment of the present invention. The computer system comprises a disk array apparatus 10 and a host (host computer) 20. The host 20 is connected to the disk array apparatus 10 by means of a host interface HI, such as a small computer system interface (SCSI) or a fibre channel. The host 20 uses the disk array apparatus 10 as an external storage.

The disk array apparatus 10 comprises at least one array (physical array) and at least one array controller. According to the embodiment, the disk array apparatus 10 comprises four arrays 11a(#a), 11b(#b), 11c(#c) and 11d(#d), and a dual type of controller made up of array controller 12-1 and array controller 12-2. Each array 11i (i=1, b, C, d) is constituted by defining the storage area of at least one disk drive as its physical area (an array area). In the case of this embodiment, each array 11i is constituted by defining the storage areas of a plurality of hard disk drives (HDDs) as its physical array area.

The array controllers 12-1 and 12-2 are connected to each of the arrays 11i (that is, they are connected to the HDDs constituting the arrays 11i) by means of a storage interface SI, such as SCSI or a fibre channel. In response to a data read/write request made by the host 20, the array controllers 12-1 and 12-2 operate the HDDs of the arrays 11i in parallel and execute data read/write operation in a distributed fashion. The array controllers 12-1 and 12-2 are synchronized and kept in the same state by communicating with each other.

Array controllers 12-1 and 12-2 include virtualization units 120-1 and 120-2, respectively. The virtualization units 120-1 and 120-2 combine arbitrary slices of the arbitrary arrays 11i and provide them as at least one logical disk recognized by the host 20. Details of “slice” will be described later. Virtualization unit 120-1 comprises a logical disk configuration unit 121 and a map table 122. Logical disk configuration unit 121 includes an array/slice definition unit 121a, a logical disk definition unit 121b, a slice moving unit 121c, a data read/write unit 121d and a statistical information acquiring unit 121e. Although not shown, virtualization unit 120-2 has a similar configuration to that of virtualization unit 120-1.

Logical disk configuration unit 121 realized by causing the processor (not shown) of array controller 12-1 to read and execute a specific software program installed in this controller 12-1. The program is available in the form of a computer-readable recording medium, and may be downloaded from a network.

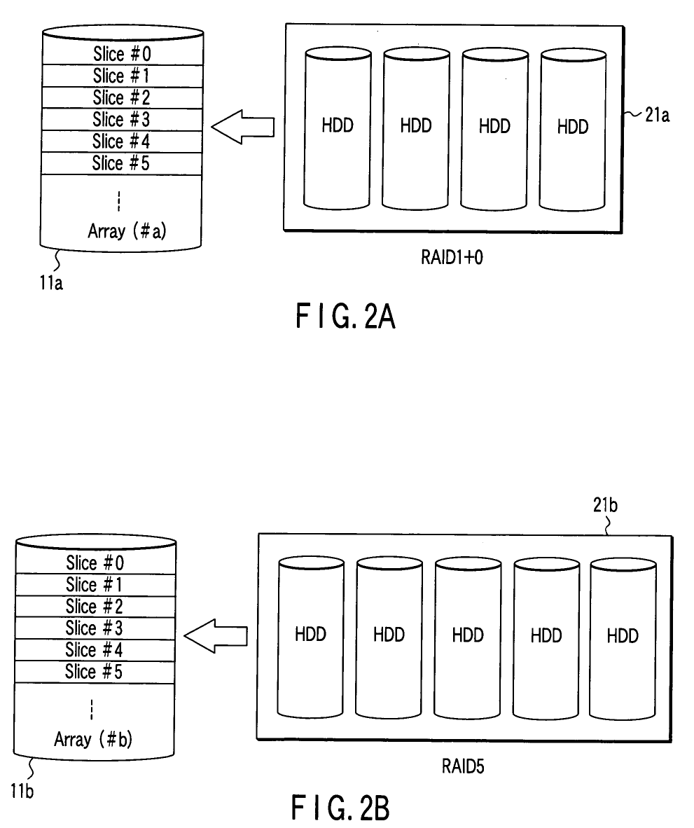

The array/slice definition unit 121a defines an array and a slice. The definitions of “array” and “slice” determined by the array/slice definition unit 121a will be described, referring to FIGS. 2A and 2B. The array/slice definition unit 121a defines at least one group (for example, it defines a plurality of groups) in such a manner that the group (each group) includes at least one HDD (for example, a plurality of HDDs). The array/slice definition unit 121a defines an array for each of the groups. Each array is defined (and managed) as an array determined according to the RAID technology. In other words, the storage areas of the HDDs of the corresponding group are used as physical areas (array areas).

Let us assume that array 11a shown in FIG. 1 is made up of four HDDs and is an array managed according to (RAID1+0) level, as shown in FIG. 2A. Let us also assume that array 11b shown in FIG. 1 is made up of five arrays and is an array managed according to RAID5 level, as shown in FIG. 2A. For the sake of simplicity, it is assumed that no HDD is used in common to the two groups constituting arrays 11a and 11b. In this case, the storage capacity of the physical area (array area) of array 11a is the same as the total storage capacity of the four HDDs, and the storage capacity of the physical area (array area) of array 11b is the same as the total storage capacity of the five HDDs.

The array/slice definition unit 121a divides the storage areas of arrays 11a, 11b, 11c and 11d into areas of a predetermined storage capacity (e.g., 1 GB). The array/slice definition unit 121a defines each of the divided areas as a slice. In other words, the array/slice definition unit 121a divides the storage areas of arrays 11a, 11b, 11c and 11d into a plurality of slices each having a predetermined storage capacity. That is, any slice of any array of the disk array apparatus 10 has the same storage capacity. This feature is important to enable the slice moving unit 121c to move the slices, as will be described below. The slices included in arrays 11a, 11b, 11c and 11d are assigned with numbers (slice numbers) used as IDs (identification information) of the slices. The slice numbers of the slices are assigned in the address ascending orders of the arrays. This means that the slice numbers of the slices of the arrays also represent the physical positions of the slices in the corresponding arrays.

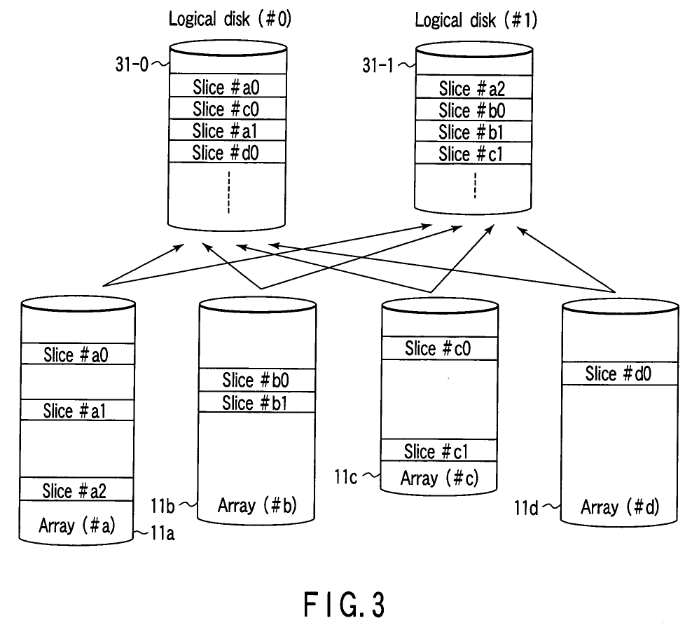

The logical disk definition unit 121b defines a logical disk which the host 20 recognizes as a single disk (disk volume). How the logical disk definition unit 121b determines the definition of a logical disk will be described, referring to FIG. 3. The logical disk definition unit 121b couples (combines) a plurality of arbitrary slices included in at least one arbitrary array to one another (with one another). The logical disk definition unit 121b defines a logical disk in which the coupled (combined) arbitrary slices are managed as logical storage area. In the example shown in FIG. 3, a group of slices including slice #a0 of array 11a, slice #c0 of array 11c, slice #a1 of array 11a and slice #d0 of array 11d are combined (coupled) together, and the resultant combination of the slices is defined as logical disk 31-0 (#0). Likewise, a group of slices including slice #a2 of array 11a, slice #b0 of array 11b, slice #b1 of array 11b and slice #c0 of array 11c are combined together, and the resultant combination of the slices is defined as logical disk 31-1 (#1).

In this manner, the storage area of the logical disk is discontinuous at positions corresponding to the boundaries between the slices, and the storage capacity of the logical disk is represented by (storage capacity of one slice)×(number of slices). The logical disk constitutes a unit which the host 20 recognizes as a single disk area (disk volume). In other words, the host 20 recognizes the logical disk as if it were a single HDD. The slices of the logical disk are assigned with slice numbers in the logical address ascending order of the logical disk. As can be seen from this, each of the slices of the logical disk are managed based on two slice numbers: one is a slice number representing where the logical position of that slice is in the logical disk, and the other is a slice number representing where the physical position of that slice is in the corresponding array.

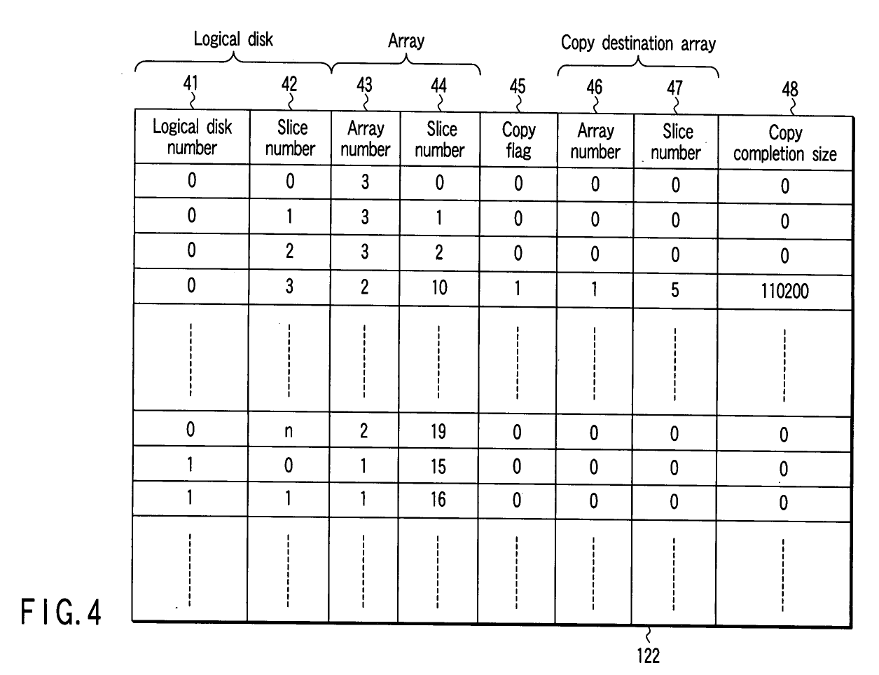

The map table 122 stores map information representing how logical disks are associated with arrays. FIG. 4 shows an example of a data structure of the map table 122. In the example shown in FIG. 4, the information on slices is stored in the row direction of the map table 122 in such a manner that the slice corresponding to the smallest address of the logical disk comes first and the remaining slices follow in the ascending order of the address of the logical disk. In the case of the present embodiment, the information on each of the slices included in a logical disk includes information to be stored in fields (items) 41 to 48. In field 41, a logical disk number is stored. The logical disk number is identification (ID) information of the logical disk to which a slice is assigned. In field 42, a slice number representing where a slice is in the logical disk is stored. In field 43, an array number is stored. The array number is an array ID representing the array to which a slice belongs. In field 44, a slice number representing where a slice is in the array is stored. In field 45, a copy flag is stored. The copy flag indicates whether or not the data in a slice is being copied to another slice. In field 46, an array number is stored. This array number indicates an array to which the data in a slice is being copied. In field 47, a slice number is stored. This slice number indicates in which slice of the destination array the data in a slice is being copied. In field 48, size information is stored. The size information represents the size of data for which copying has been completed. It should be noted that the map table 122 does not include positional information representing the relationships between the position of each slice in the corresponding array and the position of each slice in the corresponding HDD. The reason for this is that the position where each slice of an array is in the corresponding HDD can be determined based on the slice number of the slice (i.e., the slice number representing where the slice is located in the array) and the size of the slice. Needless to say, the positional information described above may be stored in the map table 122.

The slice moving unit 121c moves the data of arbitrary slices of the logical disk. The data of slices is moved as follows. First of all, the slice moving unit 121c makes a copy of the data of an arbitrary slice (a first slice) of an arbitrary logical disk and supplies the copy to a slice (a second slice) which is not assigned or included in the logical disk. Then, the slice moving unit 121c replaces the slices with each other. To be more specific, the slice moving unit 121c processes the former slice (the first slice) as a slice not included in the logical disk (i.e., as an unused slice), and processes the latter slice (the second slice) as a slice included in the logical disk (i.e., as a slice assigned to the logical disk).

According to this embodiment, only by replacing slices to be entered (allocated) to a logical disk, a logical disk can be reconstructed easily. Thus, even after the operation is started, it is possible to easily meet changes in access load without stopping use of the logical disk (that is, on line), thereby improving access performance.

A detailed description will be given of the slice movement performed by the slice moving unit 121c, with reference to the map table 122 shown in FIG. 4. Let us assume that the slice having slice number 3 and included in the logical disk of logical disk number 0 is to be moved. The slice having slice number 3 corresponds to the slice having slice number 10, which is included in the array of array number 2. The data of the slice of slice number 3 is to be copied to the slice of slice number 5, which is included in the array of array number 1. The process of the copying operation (the point of the slice of slice number 5 to which the data has been copied) is indicated by the size information stored in field 48.

After copying all data that are stored in the slice of slice number 3, the slice moving unit 121c replaces the copy source slice and the copy destination slice with each other. In this manner, the slice moving unit 121c switches the slice of slice number 3 included in the logical disk of logical disk number 0 from the slice of slice number 10 included in the array of array number 2 to the slice of slice number 5 included in the array of array number 1. As a result, the physical assignment of the slice of slice number 3 included in the logical disk of logical disk number 0 is moved or changed from the slice of slice number 10 included in the array of array number 2 to the slice of slice number 5 included in the array of array number 1. After completion of the copying operation, the copy flag is cleared (“0” clear), and the array number and slice number which specify the array and slice to which data is copied are also cleared (“0” clear).

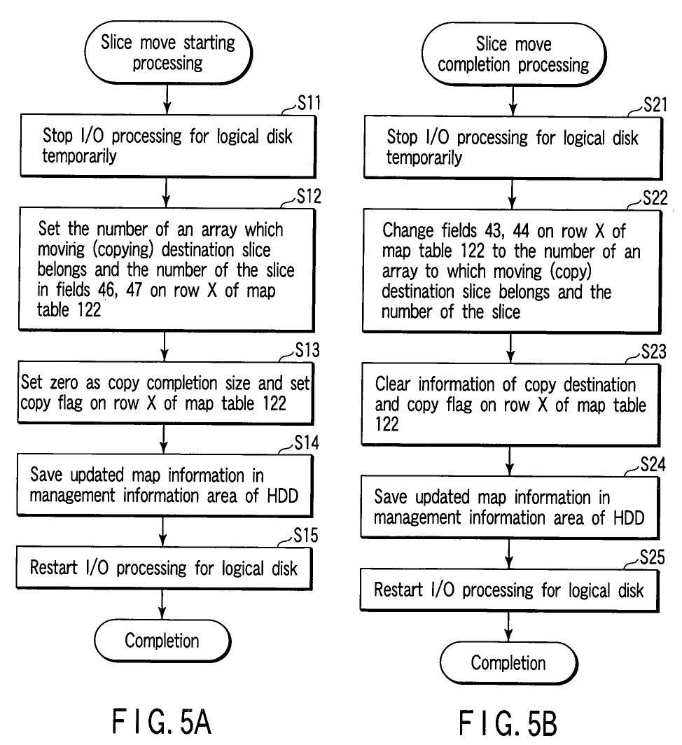

A description will now be given as to how the slice moving unit 121c starts and ends the slice movement. First, how to start the slice movement will be described, referring to the flowchart shown in FIG. 5A. First of all, the slice moving unit 121c temporarily prohibits the array controller 12-1 from performing I/O processing (a data read/write operation) with respect to the logical disk for which slice movement is to be executed (Step S11). It is assumed here that the row of the map table 122 related to the slice for which movement (or copying) is to be performed will be referred to as row X of the map table 122. After executing step S1, the slice moving unit 121c advances to step S12. In this step S12, the slice movement unit 121c sets an array number and a slice number in fields 46 and 47 of row X of the map table 122, respectively. The array number indicates an array to which the copy destination slice belongs, and the slice number indicates a slice which is a copy destination.

Then, the slice moving unit 121c sets a copy completion size of “0” in field 48 of row X of the map table 122 (Step S13). In this step S13, the slice moving unit 121c sets a copy flag in field 45 of row X of the map table 122. Next, the slice moving unit 121c saves the contents of the map table 122 (Step S14), including the information of the row updated in Steps S12 and S13. The map table 122 is saved in a management information area, which is provided in each of the HDDs of the disk array apparatus 10. The management information area will be described later. The slice moving unit 121c allows the array controller 12-1 to resume the I/O processing (a data read/write operation) with respect to the logical disk for which slice movement was executed (Step S15).

How to end the slice movement will be described, referring to the flowchart shown in FIG. 5B. At the end of the slice copying (moving) operation, the slice moving unit 121c temporarily prohibits the array controller 12-1 from performing I/O processing with respect to the logical disk for which slice movement was executed (Step S21). Then, the slice movement unit 121c sets an array number and a slice number in fields 43 and 44 of row X of the map table 122, respectively. The array number indicates an array to which the copy destination slice belongs, and the slice number indicates a slice which is a copy destination.

Then, the slice moving unit 121c clears the array number (which indicates an array to which the copy destination slice belongs) and the slice number (which indicates a copy destination slice) from fields 46 and 47 of row X of the map table 122 (Step S23). In Step S23, the slice moving unit 121c also clears the copy flag from field 45 of row X of the map table 122. Next, the slice moving unit 121c saves the contents of the map table 122 (Step S24), including the information of the row updated in Steps S22 and S23. The map table 122 is saved in the management information area, which is provided in each of the HDDs of the disk array apparatus 10. The slice moving unit 121c allows the array controller 12-1 to resume the I/O processing with respect to the logical disk for which slice movement was executed (Step S25).

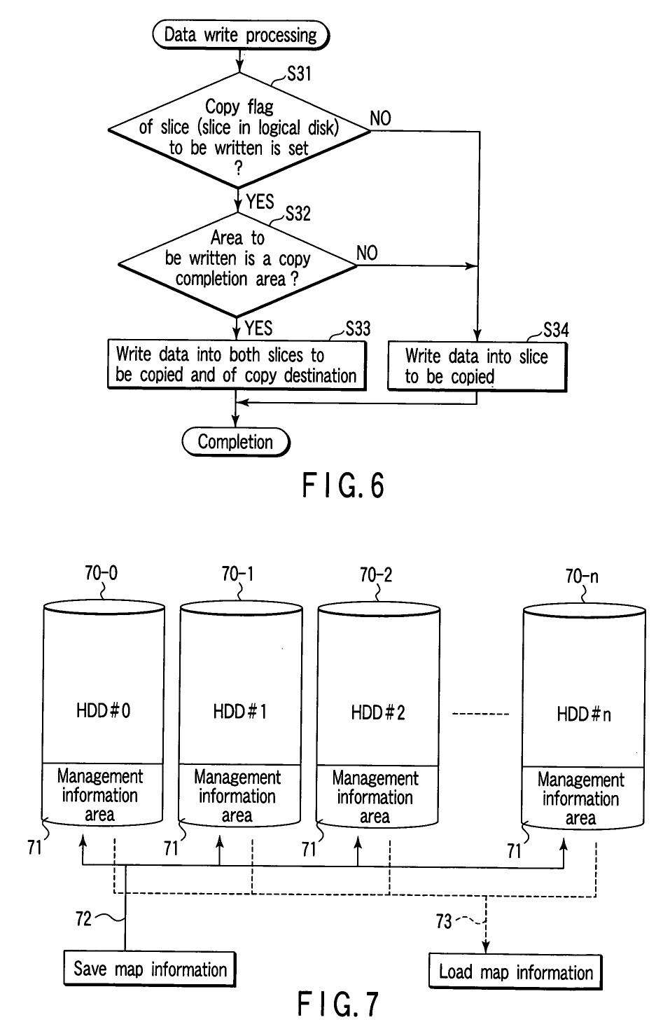

In the present embodiment, the slice copying (moving) operation described above can be performed when the logical disk to which the slice is assigned is on line (i.e., when that logical disk is in operation). To enable this, the data read/write unit 121d has to perform the data write operation (which complies with the data write request supplied from the host 20 to the disk array apparatus 10) according to the flowchart shown in FIG. 6. A description will now be given with reference to FIG. 6 as to how the data write processing is performed where the data write request the host 20 supplies to the disk array apparatus 10 pertains to a slice subject to a copying operation. It is assumed here that the row of the map table 122 related to the slice for which the write operation is to be performed will be referred to as row Y of the map table 122.

First of all, the read/write unit 121d determines whether a copy flag is set in field 45 of row Y of the map table 45 (Step S31). The copy flag is set in this example. Where the copy flag is set, this means that the slice for which the write operation is to be performed is being used as a copy source slice. In this case, the data read/write unit 121d determines whether the copying operation has been performed with respect to the slice area to be used for the write operation (Step S32). The determination in Step S32 is made based on the size information stored in field 48 of row Y of the map table 122.

Let us assume that the copying operation has been performed with respect to the slice area to be used for the write operation (Step S32). In this case, the data read/write unit 121d writes data in the areas of the copy source slice (from which data is to be moved) and the copy destination slice (to which the data is to be moved) (Step S33). The copying operation may not successfully end for some reason or other. To cope with this, it is desirable that data be written not only in the copy destination slice but also in the copy source slice (double write).

There may be a case where the slice to be used for the write operation is not being copied (Step S31), or a case where the copying operation has not yet been completed with respect to the slice area to be used for the write operation (Step S32). In these cases, the data read/write unit 121d writes data only in the area for which the write operation has to be performed and which is included in the copy source slice (Step S34).

How to save the map table 122 will now be described with reference to FIG. 7. The map table 122 is an important table that associates logical disks with the physical assignment of the slices that constitute the logical disks. If the information stored in the map table 122 (the map information) is lost, this may result in data loss. Therefore, the information in the map table 122 must not be lost even if both array controllers 12-1 and 12-2 should fail at a time or if power failure should occur. The present embodiment uses a saving method which is sufficiently redundant for the failure or replacement of an array controller or an HDD and which is effective in preventing data loss. In addition, the present embodiment follows the procedures that prevent the information in the map table from being lost even in the flowcharts shown in FIGS. 5A and 5B. That is, the present embodiment allows the I/O processing requested by the host to be resumed after the information in the map table 122 updated in accordance with the slice movement is saved.

Let us assume that (n+1) HDDs 70-0 to 70-n shown in FIG. 7 are connected to the array controllers 12-1 and 12-2 of the disk array apparatus 10 shown in FIG. 1. The present embodiment uses these HDDs 70-0 to 70-n in the manner mentioned below, so as to reliably retain the information in the map table 122. The storage areas of the HDDs 70-0 to 70-n are partially used as management information areas 71. Each management information area 71 is a special area that stores management information the array controllers 12-1 and 12-2 use for disk array management. The management information areas 71 are not used as slices. In other words, the management information areas 71 cannot be used as areas (user volumes) with reference to which the user can freely read or write information.

In steps S14 and S24 of the flow chart of FIGS. 5A and 5B, information (map information) of the updated map table 122 is redundantly stored in the management information areas 71 of HDDs 70-0 to 70-n as indicated with an arrow 72 in FIG. 7. As a consequence, the map table 122 is multiplexed into (n+1). Reading of the map table 122 is carried out in all the management information areas 71 in the HDDs 70-0 to 70-n as shown with an arrow 73 in FIG. 7. Here, n+1 pieces of information (map information) of the map table 122 are compared, and correct information is decided according to, for example, majority operation. As a result, this system can withstand troubles in the HDD or array controller.

The statistical information acquiring unit 121e shown in FIG. 1 acquires statistical information relating to I/O processing (access processing) with respect to a slice (hereinafter referred to as I/O statistical information) for each slice. The acquired I/O statistical information for each slice is stored in a predetermined area of a memory (not shown) of the array controller 12-1, for example, in a predetermined area of a random access memory (RAM). The I/O statistical information includes, for example, the number of times of write per unit time, the number of times of read per unit time, a transmission size per unit time and an I/O processing time. Generally speaking, this kind of I/O statistical information is acquired for each logical disk or each HDD as described in the aforementioned Jpn. Pat. Appln. KOKAI Publication No. 2003-5920. However, according to this embodiment, it should be noticed that to adjust access load to an array or HDD by moving the slice, the I/O statistical information for each slice is utilized for determination on the load adjustment. Naturally, a statistical value of the I/O processing in each logical disk or array can be also calculated by use of a value indicated by the statistical information for each slice (for example, adding).

According to the embodiment, the I/O statistical information acquired for each slice is used. In this case, the slice moving unit 121c checks I/O statistical information, thereby determining whether or not a statistical value indicated by the I/O statistical information exceeds a preliminarily defined threshold. If the statistical value exceeds the threshold value, the slice moving unit 121c automatically moves slices following a preliminarily defined policy. As a consequence, when access load to an array exceeds a certain rate (N %) of the performance of the array, the slice moving unit 121c can automatically replace a specified number of slices with slices of an array having the lowest load. Additionally, by reviewing an allocation of slices every predetermined cycle, the slices can be replaced such that slices having RAID1+0 level are used for slices having high access load and slices having RAID5 level are used for slices having low access load.

Hereinafter, explanation will be given for a method of adjusting access load to an array or HDD by moving a slice by use of I/O statistical information acquired by the statistical information acquiring unit 121e. Here, the following four access load adjustment methods will be described in succession;
(1) Method of reducing seek time in HDD
(2) Method of eliminating hot spot in array
(3) Method of optimizing RAID level
(4) Method of expanding capacity of logical disk
   (1) Method of Reducing Seek Time in HDD

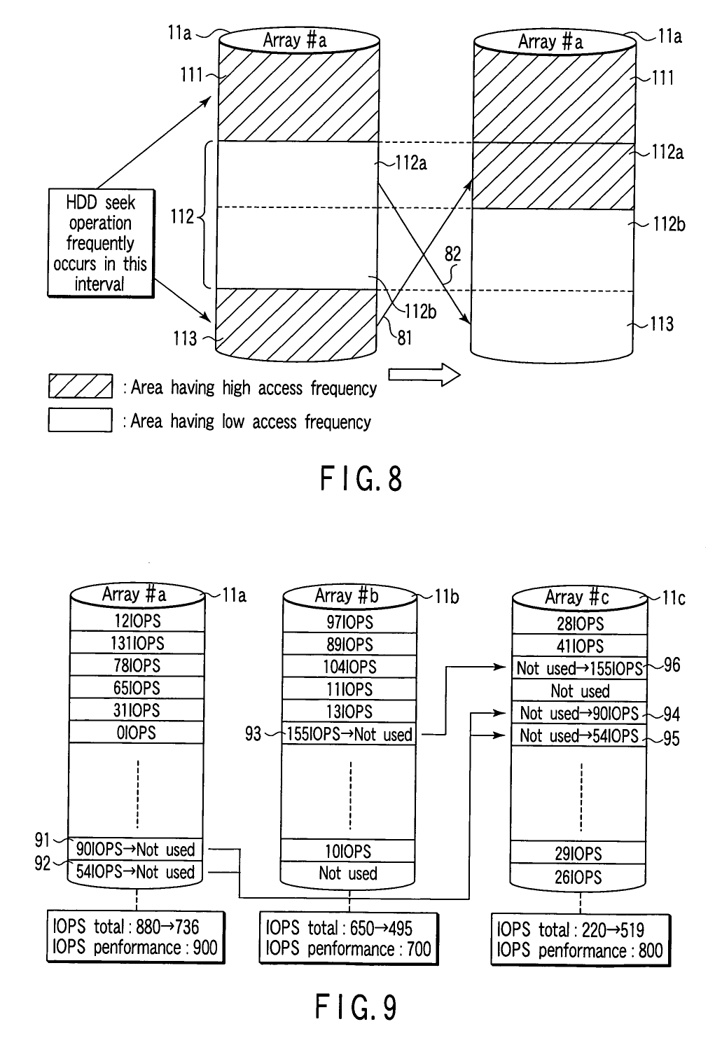

First, a method of reducing a seek time in an HDD will be described with reference to FIG. 8. Generally, upon seek operation of moving a head from a certain cylinder to another cylinder in the HDD, the longer the distance between the both cylinders, the longer time is taken for the seek operation (seek time). Therefore, as areas (addresses) having high access frequency (access load) approach each other, the seek time is reduced to improve the performance.

FIG. 8 shows a state before slices in the array 11a (#a) shown in FIG. 1 are replaced and a state after the slices are replaced by comparison. In the array 11a (#a) before the slices are replaced, areas 111 and 113 having high access frequency exist at both ends of a smaller address (upper in the figure) and a larger address (lower in the figure). An area 112 having low access frequency exists between the areas 111 and 113. In this case, the HDDs constituting the array 11a (#a) also turns into the same state as the array 11a, and an area having low access frequency exists between two areas having high access frequency. Thus, in the HDDs constituting the array 11a, a seek operation for moving the head frequently occurs between the two areas having high access frequency. In this case, the seek time increases, so that the access performance of the HDDs, that is, the access performance of the array 11a drops.

By exchanging the slices in the array 11a in such a state, areas having high access frequency are gathered on one side of the array 11a. As a consequence, the seek time of access to the array 11a is decreased, so that the access performance of the array 11a is improved. The area having high access frequency in the array 11a (#a) refers to an area in which slices whose access load (for example, the number of times of input/output per second) indicated by I/O statistical information acquired by the statistical information acquiring unit 121e exceeds a predetermined threshold are continuous. The area having low access frequency in the array 11a (#a) refers to an area in the array 11a (#a) excluding the area having high access frequency. Unused slices not entered into the logical disk (not allocated to) belong to the area having low access frequency.

Now, it is assumed that the size of the area 112 having low access frequency is larger than the size of the area (second area) 113 having high access frequency. According to the embodiment, the slice moving unit 121c moves data of slices belonging to the area 113 having high access frequency to an area 112a of the same size as the area 113 in the area 112 having low access frequency subsequent to the area (first area) 111 having high access frequency as indicated with an arrow 81 in FIG. 8. In parallel to this, the slice moving unit 121c moves data of the slices belonging to the area 112a to the area 113 having high access frequency as indicated with an arrow 82 in FIG. 8. The slice moving unit 121c replaces slices belonging to the area 113 with slices belonging to the area 112a. In this manner, the slices are exchanged, so that, in the array 11a (#a) after the exchange, the area 111 and the area 112 subsequent to the area 111 turn to an area having high access frequency while remaining continuous area 112b and 113 turn to an area having low access frequency. That is, areas having high access frequency can be gathered on one side of the array 11a (#a).

The exchange of the slices by the slice moving unit 121c can be executed in the following procedure while using the logical disk. First, the slice moving unit 121c designates slices to be exchanged to be a slice (first slice) #x and a slice (third slice) #y. Assume that the slices #x, #y are i-th slices in the areas 113 and 112a, respectively. Further, the slice moving unit 121c prepares a work slice (second slice) #z not entered into any logical disk. Next, the slice moving unit 121c copies data of the slice #x to slice #z and exchanges the slice #x with the slice #z. Then, the slice moving unit 121c causes the slice #z to enter the logical disk. Next, the slice moving unit 121c copies data of the slice #y to the slice #x and exchanges the slice #y with the slice #x. Next, the slice moving unit 121c copies data of the slice #z to the slice #y and exchanges the slice #z with the slice #y. As a consequence, exchange of the i-th slice #x in the area 113 with the i-th slice #y in the area 112a is completed. The slice moving unit 121c repeats the exchange processing between respective slices within the area 113 and respective slices within the area 112a that is same in relative position as the former slices.

(2) Method of Eliminating Hot Spot in Array

According to this embodiment, the hot spot can be eliminated by eliminating concentration of access on a specific array to equalize access between arrays. A method of eliminating the hot spot will be described with reference to FIG. 9. FIG. 9 indicates three arrays 11a (#a), 11b (#b) and 11c (#c). The capacities of the respective arrays differ depending on the type and number of HDDs constituting the array, the RAID level for use in management of the array, and the like. The capacities of the arrays 11a, 11b and 11c are expressed in the number of times of input/output per second, that is, a so-called IOPS value, and these are 900, 700 and 800, respectively. On the other hand, the statistical information acquired by the statistical information acquiring unit 121e includes IOPS values of slices of the arrays 11a, 11b and 11c, and the totals of the IOPS values of the slices of the arrays 11a, 11b and 11c are 880, 650 and 220, respectively.

In the above example, the arrays 11a and 11b are accessed from the host 20 up to near the upper limit of the performance of the arrays 11a and 11b. Contrary to this, there exist a number of slices not used, that is, slices not allocated to any logical disk in the array 11c. Thus, the array 11c has an allowance in its processing performance. Then, the slice moving unit 121c moves data of slices (slices having high access frequency) in part of the arrays 11a and 11b to unused slices in the array 11c based on the IOPS value (statistical information) for each slice. In this manner, the processing performance of the arrays 11a and 11b can be supplied with an allowance.

In the example shown in FIG. 9, data of slices 91 and 92 in the array 11a whose IOPS values are 90 and 54, respectively, and data of slice 93 in the array 11b whose IOPS value is 155 are moved to unused slices 94, 95 and 96 in the array 11c. Then, the slices 94, 95 and 96 which are data moving destinations are allocated to a corresponding logical disk (entered into) instead of the slices 91, 92 and 93 which are data moving origins. The slices 91, 92 and 93 which are data moving destinations are released from a state of being allocated to the logical disk and turn to unused slices. As a result, the totals of the IOPS values of the arrays 11a and 11b decrease from 880 and 650 to 736 and 495, respectively. In the meantime, the method of moving the slice (exchanging) is the same as described above.

As described above, method (2) solves the “hot spot” problem of the array by moving data from the slices having a high access frequency to unused slices. Needles to say, however, the load applied to the arrays may be controlled by exchanging the slices having a high access frequency with the slices having a low access frequency, as in method (1) described above.

(3) Method of Optimizing RAID Level

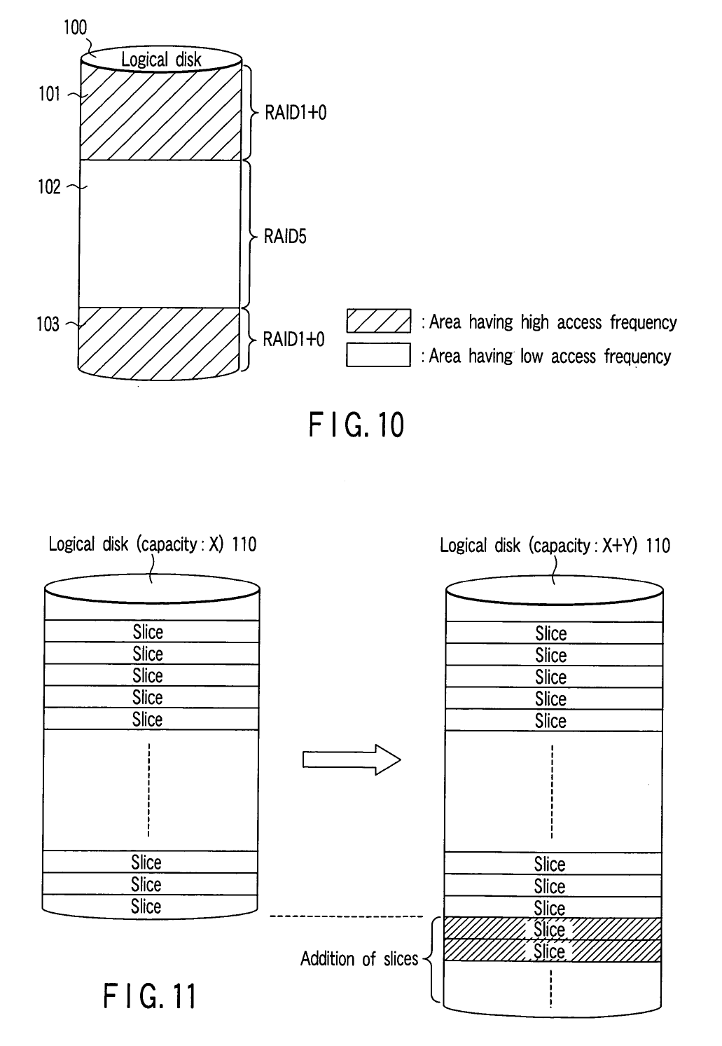

Next, a method of optimizing the RAID level will be described with reference to FIG. 10. According to this embodiment, like the array 11a of FIG. 8, the area within the logical disk can be divided (classified) to an area having high access frequency and an area having low access frequency. The statistical information acquired by the statistical information acquiring unit 121e is used for the division. FIG. 10 shows a state in which a logical disk 100 is divided to an area 101 having high access frequency, an area 102 having low access frequency and an area 103 having high access frequency.

The logical disk definition unit 121b reconstructs the areas 101 and 103 having high access frequency within the logical disk 100 with slices of an array adopting the RAID level 1+0, which is well known to have an excellent performance, as shown in FIG. 10. Further, the logical disk definition unit 121b reconstructs the area 102 having low access frequency within the logical disk 100 with slices of an array adopting the RAID5 which is well known to have an excellent cost performance, as shown in FIG. 10. According to this embodiment, such tuning can be executed while using the logical disk.

The reconstruction of the areas 101, 102 and 103 is achieved by replacing slices within the array allocated to those areas with unused slices in the array adopting an object RAID level in accordance with the above-described method. If exchanging the RAID level of the slices constituting the areas 101 and 103 with the RAID level of the slices constituting the area 102 satisfies the purpose, slices between areas having the same size are merely exchanged in the same manner as in the method of reducing the seek time in the HDD.

(4) Method of Expanding Capacity of Logical Disk

According to this embodiment, the logical disk is constituted by the unit having a small capacity, which is a slice. Therefore, when the capacity of the logical disk is short, the capacity of the logical disk can be flexibly expanded by coupling an additional slice to the logical disk. A method of expanding the capacity of the logical disk will be described with reference to FIG. 11. FIG. 11 shows a logical disk 110 whose capacity is X. When the capacity of the logical disk 110 needs to be expanded from X to X+Y, the logical disk definition unit 121b couples slices of a number corresponding to a capacity Y to the logical disk 110, as shown in FIG. 11.

FIG. 1 indicates only the host 20 as a host using the disk array apparatus 10. However, by connecting a plurality of hosts including the host 20 with the disk array apparatus 10, the plurality of hosts can share the disk array apparatus 10.

[First Modification]

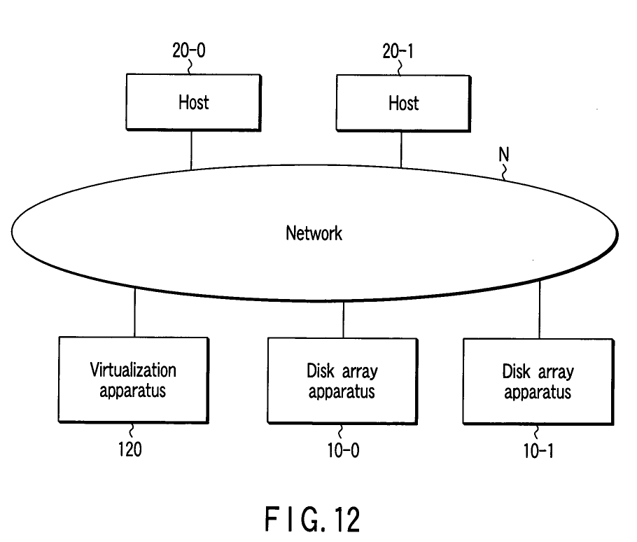

Next, a first modification of the above-described embodiment will be described with reference to FIG. 12. According to the above embodiment, the disk array apparatus 10 and the host 20 are connected directly. However, recently, a computer system, in which at least one disk array apparatus, for example, a plurality of disk array apparatuses and at least one host, for example, a plurality of hosts are connected with a network called storage area network (SAN), has appeared.

FIG. 12 shows an example of such a computer system. In FIG. 12, disk array apparatuses 10-0 and 10-1 and hosts 20-0 and 20-1 are connected with a network N like SAN. The hosts 20-0 and 20-1 share the disk array apparatuses 10-0 and 10-1 as their external storage units. However, the disk array apparatuses 10-0 and 10-1 are not recognized from the hosts 20-0 and 20-1. That is, the disk array apparatuses 10-0 and 10-1 are recognized as a logical disk achieved by using the storage area of the HDDs possessed by the disk array apparatuses 10-0 and 10-1, from the hosts 20-0 and 20-1.

In the system shown in FIG. 12, a virtualization apparatus 120, which is similar to the virtualization units 120-1 and 120-2 shown in FIG. 1, is provided independently of an array controller (not shown) of the disk array apparatuses 10-0 and 10-1. The virtualization apparatus 120 is connected to the network N. The virtualization apparatus 120 defines (constructs) a logical disk by coupling plural slices within an array achieved by using the storage area of the HDDs possessed by the disk array apparatuses 10-0 and 10-1. The logical disk is recognized as a single disk (disk volume) from the hosts 20-0 and 20-1.

[Second Modification]

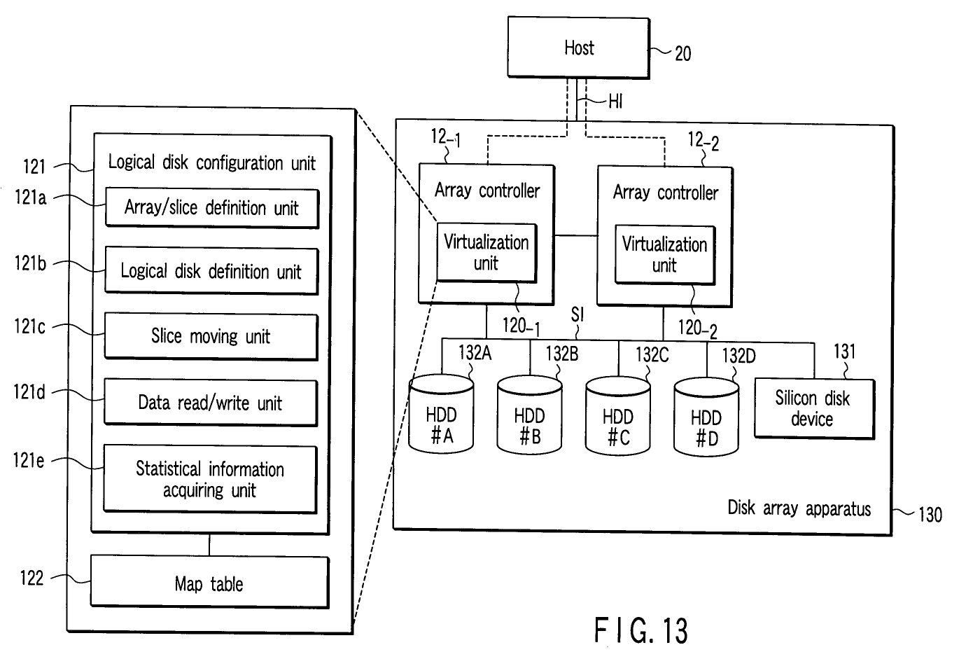

Next, a second modification of the above embodiment will be described with reference to FIG. 13. FIG. 13 is a block diagram showing a configuration of a computer system provided with the disk array apparatuses according to the second modification of the embodiment of the present invention. In FIG. 13, like reference numerals are attached to the same components as elements shown in FIG. 1. The computer system of FIG. 13 comprises a disk array apparatus 130 and the host 20. The disk array apparatus 130 is different from the disk array apparatus 10 shown in FIG. 1 in that it has a silicon disk device 131. The silicon disk device 131 is a storage device such as a battery backed-up type RAM disk device, which is constituted of plural memory devices such as dynamic RAMs (DRAMs). The silicon disk device 131 is so designed that the same access method (interface) as used for the HDD can be used to access the device 131 from the host. Because the silicon disk device 131 is constituted of memory devices, it enables a very rapid access although it is very expensive as compared to the HDD and has a small capacity.

The disk array apparatus 130 has HDDs 132A (#A), 132B (#B), 132C (#C) and 132D (#D). The HDDs 132A and 132B are cheap and large volume HDDs although their performance is low, and are used for constituting an array. The HDDs 132C and 132D are expensive and small volume HDDs although their performance is high, and are used for constituting an array. The HDDs 132A, 132B, 132C and 132D are connected to array controllers 12-1 and 12-2 through a storage interface SI together with the silicon disk device 131.

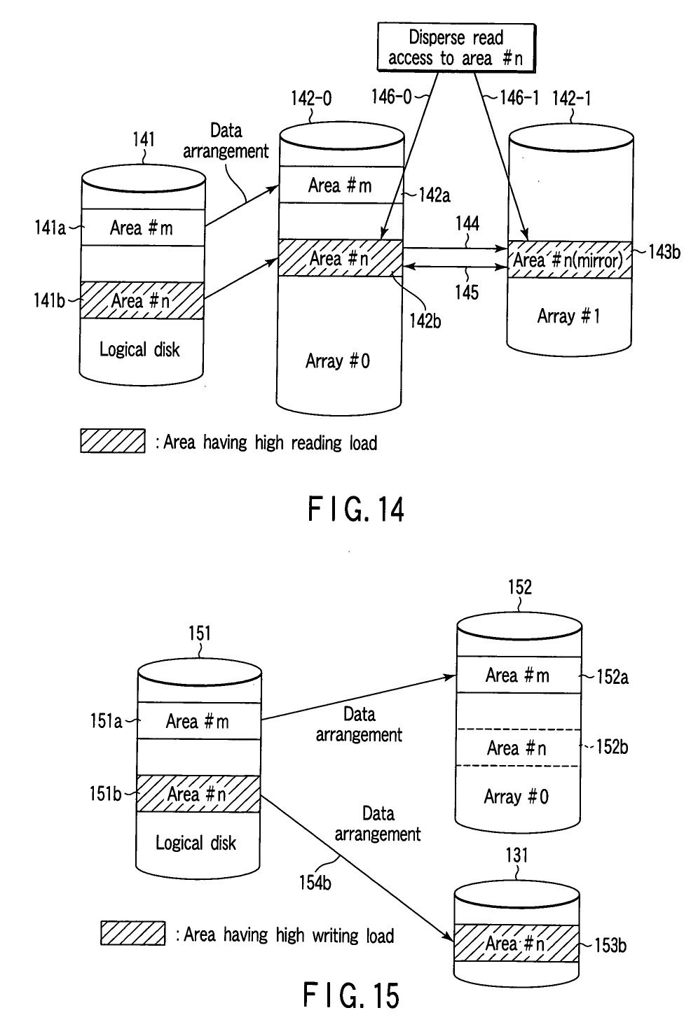

A method of eliminating drop of the read access performance (read performance) of the logical disk, applied to the second modification, will be described with reference to FIG. 14. FIG. 14 shows a logical disk 141 constituted of a plurality of slices. The logical disk 141 includes areas 141a (#m) and 141b (#n). The areas 141a (#m) and 141b (#n) of the logical disk 141 are constructed by combining physically continuous slices constituting areas 142a (#m) and 142b (#n) of an array 142-0 (#0). Here, assume that access to slices in the area 141a (#m) or 141b (#n) of the logical disk 141 is requested. In this case, a corresponding slice in the area 142a (#m) or 142b (#n) of the array 142-0 (#0) is physically accessed.

Assume that the number of times of read per unit time of each of slices constituting the area 141b (#n) of the logical disk 141 is over a predetermined threshold. On the other hand, assume that the number of times of read per unit time of each of slices constituting the area 141a (#m) of the logical disk 141 is not over the aforementioned threshold. That is, assume that load (reading load) of read access to the area 141b (#n) of the logical disk 141 is high while reading load to the area 141a (#m) of the logical disk 141 is low. In this case, upon read access to the logical disk 141, the area 142b (#n) of the array 142-0 (#0) corresponding to the area 141b (#n) of the logical disk 141 turns to a bottle neck. As a result, the read access performance of the logical disk 141 drops.

The slice moving unit 121 can detect an area of the logical disk 141 in which slices having high reading load continue as an area having high reading load on the basis of the number of times of read per unit time indicated by the I/O statistical information for each slice acquired by the statistical information acquiring unit 121e. Here, the slice moving unit 121 detects the area 141b (#n) of the logical disk 141 as an area having high reading load. Then, the array/slice definition unit 121a defines a new array 142-1 (#1) shown in FIG. 14. According to this definition, the slice moving unit 121 assigns to the array 142-1 (#1) an area 143b (#n) serving as a replica (mirror) of the area 142b (#n) in the array 142-0 (#0) as indicated with an arrow 144 in FIG. 14. Slices included in the area 143b (#n) of the array 142-1 turn to replicas of slices included in the area 142b (#n) of the array 142-0 (#0). The area 142b (#n) of the array 142-0 (#0) corresponds to the area 141b (#n) of the logical disk 141 as described above.

Assume that, in such a state, data write to a slice contained in the area 141b (#n) of the logical disk 141 is requested to the disk array apparatus 130 from the host 20. In this case, the data read/write unit 121d writes the same data into the area 142b (#n) of the array 142-0 (#0) and the area 143b (#n) of the array 142-1 (#1) as indicated with an arrow 145 in FIG. 14. That is, the data read/write unit 121d writes data into a corresponding slice contained in the area 142b (#n) of the array 142-0 (#0). At the same time, the data read/write unit 121d writes (mirror writes) the same data into a corresponding slice contained in the area 143b (#n) of the array 142-1 (#1) as well.

On the other hand, when data read from a slice contained in the area 141b (#n) of the logical disk 141 is requested from the host 20, the data read/write unit 121d reads data as follows. That is, the data read/write unit 121d reads data from any one of a corresponding slice contained in the area 142b (#n) of the array 142-0 (#0) and a corresponding slice contained in the area 143b (#n) of the array 142-1 (#1) as indicated with an arrow 146-0 or 146-1 in FIG. 14. Here, the data read/write unit 121d reads data from the area 142b (#n) or the area 143b (#n) such that its read access is dispersed to the area 142b (#n) of the array 142-0 (#0) and the area 143b (#n) of the array 142-1 (#1). For example, the data read/write unit 121d alternately reads data from the area 142b (#n) of the array 142-0 (#n) and the area 143b (#n) of the array 142-1 (#1) each time when data read from the area 141b (#n) of the logical disk 141 is requested form the host 20.

According to the second modification, in this way, the area 143b (#n) which is a replica of the area 142b (#n) containing slices having high reading load within the array 142-0 (#0) is assigned to other array 142-1 (#1) than the array 142-0 (#0). As a result, read access to the area 142b (#n) can be dispersed to the area 143b (#n). By this dispersion of the read access, the bottle neck of read access to the area 142b (#n) in the array 142-0 (#0) is eliminated, thereby improving the read performance of the area 141b (#n) in the logical disk 141.

Next, assume that the frequency of read access to slices contained in the area 141b (#n) of the logical disk 141 decreases, so that the reading load of the area 141b (#n) drops. In this case, the slice moving unit 121 releases the area (replica area) 142b (#n) in the array 142-0 (#0). That is, the slice moving unit 121 brings back the allocation of an area in an array corresponding to the area 141b (#n) of the logical disk 141 to its original state. As a result, by making good use of a limited capacity of the physical disk, the read access performance of the logical disk can be improved.

Next, a method of eliminating drop of the write access performance (write performance) of the logical disk, applied to the second modification will be described with reference to FIG. 15. FIG. 15 shows a logical disk 151 constituted of a plurality of slices. The logical disk 151 contains areas 151a (#m) and 151b (#n). The areas 151a (#m) and 151b (#n) of the logical disk 151 are constructed by combining physically continuing slices constituting areas 152a (#m) and 152b (#n) of an array 152, respectively.

As for the example shown in FIG. 15, assume that the number of times of write per unit time of each of slices constituting the area 151b (#n) of the logical disk 151 is over a predetermined threshold. On the other hand, assume that the number of times of write per unit time of each of slices constituting the area 151a (#m) of the logical disk 151 is not over the aforementioned threshold. In this case, the slice moving unit 121 detects the area 151b (#n) of the logical disk 151 as an area having high write access load (writing load) on the basis of the number of times of write per unit time indicated by the I/O statistical information for each slice acquired by the statistical information acquiring unit 121e. Likewise, the slice moving unit 121 detects the area 151a (#m) of the logical disk 151 as an area having low writing load.

Then, the array/slice definition unit 121a defines an area 153b (#n) corresponding to the area 151b (#n) of the logical disk 151 in a storage area of the silicon disk device 131, as shown with an arrow 154b in FIG. 15. Following the definition, the slice moving unit 121 relocates slices constituting the area 151b (#n) of the logical disk 151 from the area 152b (#n) of the array 152 to the area 153b (#n) of the silicon disk device 131. The silicon disk device 131 makes a more rapid access than the HDDs constituting the array 152. Therefore, as a result of the relocation, the write performance of the area 151b (#n) in the logical disk 151 is improved.

The silicon disk device 131 is very expensive as compared with the HDDs. Therefore, assigning all slices constituting the logical disk 151 to the silicon disk device 131 is disadvantageous in viewpoint of cost performance. However, according to the second modification, only slices constituting the area 151b having high writing load in the logical disk 151 are assigned to the silicon disk device 131. As a consequence, a small storage area of the expensive silicon disk device 131 can be used effectively.

Next assume that the frequency of write access to slices constituting the area 151b (#n) of the logical disk 151 drops, so that the writing load of the area 151b (#n) drops. In this case, the slice moving unit 121 rearranges slices contained in the area 151b (#n) of the logical disk 151 from the silicon disk device 131 to an array constituted of the HDDs, for example, the original array 152. As a result, by using the limited capacity of the expensive silicon disk device 131 further effectively, the write access performance of the logical disk can be improved.

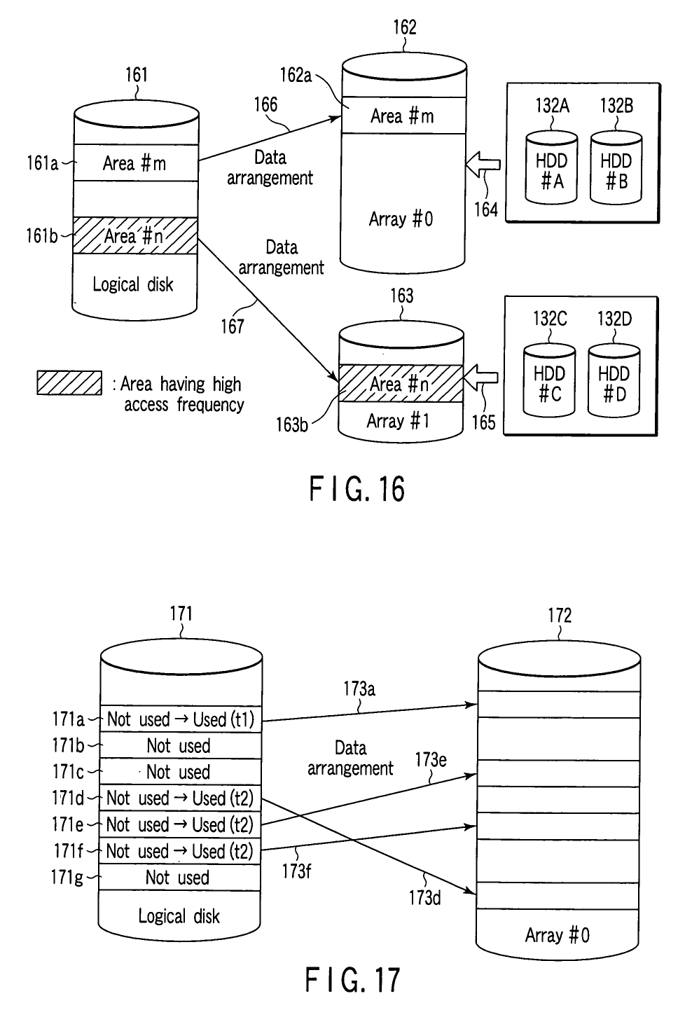

According to the second modification, the disk array apparatus 130 has HDDs 132A (#A) and 132B (#B), and HDDs 132C and 132D which are different in type from the HDDs 132A(#A) and 132B(#B). Then, a method of improving the access performance of the logical disk by using HDDs of different types, applied to the second modification, will be described with reference to FIG. 16. FIG. 16 shows a logical disk 161 constituted of a plurality of slices. The logical disk 161 contains areas 161a (#m) and 161b (#n). Assume that the area 161b (#n) of the logical disk 161 is constituted of slices whose access frequency is higher than its threshold. On the other hand, assume that the area 161a (#m) of the logical disk 161 is constituted of slices whose access frequency is lower than the threshold. In this case, the slice moving unit 121 detects the area 161b (#n) of the logical disk 161 as an area having high access frequency.

FIG. 16 shows a plurality of arrays, for example, two arrays 162 and 163. The array 162 is constructed by using storage areas of the cheap and large volume HDDs 132A (#A) and 132B (#B) although their performance is low, as indicated with an arrow 164. Contrary to this, the array 163 is constructed by using storage areas of the expensive and small volume HDDs 132C (#C) and 132D (#D) although their performance is high. In this way, the array 162 is constructed taking the capacity and cost as important, and the array 163 is constructed taking the performance as important.

The slice moving unit 121 allocates slices contained in the area 161a (#m) having low access frequency of the logical disk 161 to, for example, an area 162a of the array 162, as indicated with an arrow 166 in FIG. 16. Further, the slice moving unit 121 allocates slices contained in the area 161b (#n) of the logical disk 161 to, for example, an area 163b of the array 163, as indicated with an arrow 167 in FIG. 16. If the access frequency of the area 161a (#m) or 161b (#n) of the logical disk 161 is changed after this allocation, the slice moving unit 121 changes the array to which slices contained in the area 161a (#m) or 161b (#n) should be allocated. According to the second modification, the arrays 162 and 163 having different characteristics (type) are prepared, and the arrays to which slices constituting the area should be assigned are exchanged depending on each area having a different access performance (access frequency) within the logical disk 161. As a consequence, according to the second modification, the cost performance of the disk array apparatus 130 can be improved.

[Third Modification]

According to the above embodiment, the first modification and the second modification thereof, at a point of time when a logical disk is constructed, slices constituting the logical disk are assigned to an array. However, when a first access to slices in the logical disk is requested from the host to the disk array apparatus, those slices may be assigned within the storage area of the array.

According to the third modification, when a slice in the logical disk is used first, that is, the slice is changed from an unused slice to a used slice, an array constructing method for assigning the slices to the storage area of the array is applied. The array constructing method applied to the third modification will be described with reference to FIG. 17. The third modification is applied to the disk array apparatus 130 shown in FIG. 13 like the second modification.

FIG. 17 shows a logical disks 171 and an array 172 (#0). The logical disk 171 includes slices 171a, 171b, 171c, 171d, 171e, 171f and 171g. According to the third modification, at a point of time when the logical disk is generated (defined), any slices constituting the logical disk 171 (that is, unused slices including the slices 171a to 171g) are not assigned to the array 172 (#0). Assume that, after that, a first access from the host 20 to the slice 171a occurs at time t1 and that a first access to the slices 171d, 171e and 171f from the host 20 occurs at time t2 after the time t1.

At the time t1 when the first access to the slice 171a occurs, the array/slice definition unit 121a actually assigns an area of the array 172 to the slice 171a, as indicated with an arrow 173a in FIG. 17. Thereafter, the assignment of the slice 171a to the array 172 is completed, so that it is changed from an unused slice to a used slice. Likewise, at the time t2 when the first access to the slices 171d, 171e and 171f occurs, the array/slice definition unit 121a actually assigns areas of the array 172 to the slices 171d, 171e and 171f as indicated with arrows 173d, 173e and 173f in FIG. 17. Thereafter, assignment of the slices 171d, 171e and 171f to the array 172 is completed, so that it is changed from an unused slice to a used slice.

The array/slice definition unit 121a manages slices constituting the logical disk 171 to successively assign a physical real areas of the array 172 in order starting from a slice accessed first. The disk array apparatus 130 using the management method is optimal for a system in which actually used disk capacity increases gradually due to increases in the number of users, databases and contents when the operation continues. The reason is that when the system is constructed, a logical disk of a capacity estimated to be necessary ultimately can be generated regardless of the capacity of an actual array. Here, of all the slices in the logical disk, only slices actually used are allocated to the array. Thus, when the capacity of a disk currently used gradually increases, it is possible to add arrays depending on that increased capacity.

As a consequence, according to the third modification, initial investment upon construction up of the system can be suppressed to a low level. Further, because no area of the array is consumed for an unused area in the logical disk, the availability of the physical disk capacity increases. Further, according to the third modification, as a result of shortage of the physical disk capacity after the operation of the system is started, an array is added and the real area of the added array is assigned to slices newly used of the logical disk. Here, the logical disk itself is generated (defined) with an ultimately necessary capacity. Thus, even if any array is added and the real area of the array is assigned, there is no necessity of reviewing the configuration recognized by the host computer such as the capacity of the logical disk, so that the operation of the system is facilitated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for managing a logical disk, the logical disk being constituted by using a storage area of a disk drive and recognized as a single disk volume by a host, the method comprising:
constituting an array, the array being constituted by defining the storage area of the disk drive as a physical array area of the array, the array being constituted of a group of slices, the physical array area being divided to a plurality of areas having a certain capacity, the divided areas being defined as the slices;
constituting a logical disk by combining arbitrary plural slices of the slices contained in the array; and
exchanging an arbitrary first slice entered into the logical disk with a second slice not entered into any logical disk including the logical disk.

2. The method according to claim 1, wherein the exchanging further includes:
copying data of the first slice to the second slice; and
after data copy from the first slice to the second slice is completed, exchanging the first slice with the second slice and causing the second slice to enter the logical disk.

3. The method according to claim 1, further comprising:
acquiring statistical information about access to a slice for each slice constituting the logical disk and holding the information in a storage device;
detecting an area having high access load within the array based on the statistical information acquired for each slice; and
with a slice belonging to the detected area having high access load as the first slice, executing the exchanging.

4. The method according to claim 1, further comprising:
acquiring statistical information about access to a slice for each slice constituting the logical disk and holding the information in a storage device;
dividing the entire area of the logical disk into a plurality of areas depending on the degree of access load, based on the statistical information acquired for each slice; and
with a slice within the array assigned to an area of the divided areas as the first slice and a slice not entered into the logical disk within another array other than the array as the second slice, executing the exchanging and reconstructing said area of the divided areas with a slice applying a RAID level adapted to the degree of the access load of said area, said another array applying the RAID level adapted to the degree of the access load of said area of the divided areas.

5. The method according to claim 1, wherein the exchanging further includes:
after exchanging the first slice with the second slice, exchanging an arbitrary third slice entered into the logical disk with the first slice; and
after exchanging the third slice with the first slice, exchanging the second slice with the third slice.

6. The method according to claim 5, further comprising:
acquiring statistical information about access to a slice for each slice constituting the logical disk and holding the information in the storage device;
detecting an area having high access load within the array based on the statistical information acquired for each slice; and
when first and second areas having high access load are detected within the array, with a slice belonging to a third area within the array, the third area being of the same size as part or all of the second area subsequent to the first area as the third slice, and s slice belonging to the part or all of the second area as the first slice, executing the exchanging to relocate the part or all of the second area so as to be continuous to the first area within the array.

7. The method according to claim 1, further comprising:
acquiring statistical information about access to a slice for each slice constituting the logical disk and holding the information in a storage device;
detecting slices having high read access load, the slices being continuous within the logical disk, based on the statistical information acquired for each slice;
allocating a second area, used for storing a replica of data within the array and in the first area to which the detected slices are allocated, to another array other than the array;
when reading data of a slice contained in the first area of the logical disk is requested from a host computer, reading data from a slice corresponding to any one of the first area within the array and the second area within the other array; and
when writing data into a slice contained in the first area of the logical disk is requested from the host computer, writing the same data into a slice corresponding to the first area within the array and the second area within the other array.

8. A virtualization apparatus for managing the logical disk, the logical disk being constituted by using a storage area of a disk drive and recognized as a single disk volume from a host, the virtualization apparatus comprising:
an array/slice definition unit which constitutes an array, the array being constituted by defining the storage area of the disk drive as a physical array area of the array, the array being composed of a group of slices, the physical array area being divided to a plurality of areas under a certain capacity, the divided areas being defined as the slices;
a logical disk definition unit which constitutes a logical disk by combining arbitrary plural slices of the slices contained in the array; and
a slice moving unit which exchanges an arbitrary first slice entered into the logical disk with a second slice not entered into any logical disk including the logical disk.

9. The virtualization apparatus according to claim 8, further comprising a statistical information acquiring unit which acquires statistical information about access to a slice for each slice constituting the logical disk,
and wherein the slice moving unit detects an area having high access load within the array based on the statistical information acquired for each slice by the statistical information and regards a slice belonging to the detected area having high access load as the first slice.
